(19) United States
(12) Patent Application Publication
(10) Pub. No.: US 2010/0241510 A1
(43) Pub. Date: Sep. 23, 2010

(54) Method and Apparatus for Monitoring Effectiveness of Online Advertisement

(75) Inventor: Jianfeng Zhang, Hangzhou (CN)

Correspondence Address: LEE & HAYES, PLLC, 601 W. RIVERSIDE AVENUE, SUITE 1400, SPOKANE, WA, 99201, US

(73) Assignee: Alibaba Group Holding Limited, Grand Cayman (KY)

(21) Appl. No.: 12/293,687

(22) PCT Filed: Sep. 18, 2008
(86) PCT No.: PCT/US08/76794

§ 371 Date: Dec. 14, 2009

(30) Foreign Application Priority Data
Sep. 20, 2007 (CN) 200710153050.3

(51) Int. Cl. G06Q 30/00; G06Q 10/00

(52) U.S. Cl. 705/14.45

(57) ABSTRACT

A method and a system monitor the effectiveness of an online advertisement with improved accuracy. The method analyzes a request for visiting a target webpage, determines whether the request is from an advertisement website, and extracts from the request a monitored target identifier if the request is from an advertisement website. The method further obtains a user identifier according to the request, and records a tracking data containing the monitored target identifier and the user identifier. Upon occurrence of an advertisement effect monitoring event, the method finds a recorded tracking data containing the monitored target identifier and the user identifier associated with the event, and records an effective data of advertisement effect based on the tracking data and/or information of the advertisement effect monitoring event.

### RELATED APPLICATIONS

This application claims priority from Chinese patent application, Application No. 200710153050.3, filed Sep. 20, 2007, entitled “METHOD AND APPARATUS FOR MONITORING EFFECTIVENESS OF ONLINE ADVERTISEMENT”.

### BACKGROUND

The present disclosure relates to the technological fields of computers and communications, and in particular to methods and equipment for monitoring effectiveness of online advertisements.

With the development of the Internet, companies are increasingly spending a larger percentage of their advertisement expenses on online advertisements. An advertiser conducting electronic commerce transactions thus need a method to accurately identify effective online advertisements by monitoring the advertisement effectiveness, and accordingly pay for those advertisements that are effective. The present methods usually evaluate the effectiveness of an advertisement using specific traffic caused by an online advertisement, and calculate the charges for the online advertisement based on the specific traffic. Because ad traffic is usually measured by the number of clicks generated by the advertisement, the effectiveness of an online advertisement is usually represented by the number of clicks or a click-through rate of the advertisement.

The click-through of an online advertisement is recorded using an ad monitoring site between the advertisement site and the target site, where the target site is the website of the product being advertised (e.g., an e-commerce website), while the ad monitoring site may be a third-party site. That is, the ad monitoring site may be hosted on the server of the advertisement site, but may also be hosted on a server other than the advertisement site server or the target site server. As the user clicks on an advertisement on the Internet, a request for viewing a target webpage is sent to the ad monitoring site. Upon receiving the request, the ad monitoring site counts toward the click-through of the advertisement by one, returns the requested target webpage to the user, and does not continue to track the user behavior after that.

Although a click-through represents to a certain degree the traffic to the target site generated by the online advertisement, it does not track and analyze the post-click user behavior and cannot determine whether the traffic introduced by the advertisement has indeed lead to a desired result. In addition, this method is unable to control click frauds. Therefore, the simple click-through method does not accurately reflect the effectiveness of an online advertisement, and thus has low accuracy in monitoring the online advertisement effect, and is unable to determine the effectiveness of online advertisement spending.

### SUMMARY

Disclosed are a method and a system for monitoring the effectiveness of an online advertisement with improved monitoring accuracy. The method analyzes a request for visiting a target webpage, determines whether the request is from an advertisement website, and extracts from the request a monitored target identifier if the request is from an advertisement website. The method further obtains a user identifier according to the request, and records a tracking data containing the monitored target identifier and the user identifier. Upon occurrence of an advertisement effect monitoring event associated with the monitored target identifier and the user identifier of the tracking data, recording an effective data of advertisement effect based on the tracking data and/or information of the advertisement effect monitoring event.

Alternatively, upon occurrence of an advertisement effect monitoring event, the method identifies a recorded tracking data containing the monitored target identifier and the user identifier associated with the event, and records an effective data of advertisement effect based on the identified recorded tracking data and/or information of the event.

The system for monitoring effectiveness of online advertisement has an advertisement URL analyzing module to analyze a request for visiting the target webpage and determining if the request is from an advertising website. The system also has an advertisement tracking and recording module to extract from the request a monitored target identifier if the request is from an advertisement website, obtain a user identifier according to the request, and record a tracking data containing the monitored target identifier and the user identifier. The system further has an advertisement effect analyzing module to determine, upon occurrence of an advertisement effect monitoring event, whether there is a recorded tracking data containing monitored target identifier and user identifier associated with the event; and if affirmative, record an effective data of advertisement effect based on the identified recorded tracking data and/or information of the event.

Disclosed embodiments of the method and the system track a request for visiting a target webpage, record the request if it is from an advertising website, analyze the advertisement effect upon the occurrence of an advertisement effect monitoring event, and records effective data of advertisement effect. These embodiments may accurately reflect the effect of online advertisements and improve the accuracy of monitoring the effectiveness of the online advertisements.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is a flowchart of an exemplary method for tracking a request for visiting a target webpage.

FIG. 2 is a flowchart of an exemplary method for analyzing the effect of an online advertisement.

FIG. 3 is a flowchart of an exemplary method for analyzing the advertisement effect upon occurrence of an event of concluding a product purchase.

FIG. 4 is a structural diagram of an exemplary system for monitoring online advertisement effect.

### DETAILED DESCRIPTION

The method and the system for monitoring the effectiveness of online advertisements are illustrated using exemplary embodiments below.

In one embodiment, the request for visiting a target webpage contains a URL and user information. Typically, the user information is carried by a cookie file. For example, if the user has visited a website in the past, the cookie provided by the website may contain an identifier of the user. A cookie is a file sent by a website to the browser of a user when the user visits the website.

In this embodiment, the online advertisement monitoring method analyzes the request for visiting the target webpage and determines whether the request is from an advertisement website based on the parameters of the URL contained in the request. An advertisement website refers to a website that carries advertisements or provides advertising services. If the request is from the advertisement website, the method determines from the cookie sent along with the request whether the user has in the past visited the target website through an online advertisement. If the answer is affirmative, the method obtains the user identifier from the cookie, and if the answer is no, the method sets up and inserts a unique user identifier in the cookie.

The method extracts a monitored target identifier from the parameters carried by the URL in the request, and records a tracking data containing the monitored target identifier, the user identifier and a request date. The monitored target may be custom-defined, such as a product being advertised.

Upon occurrence of an advertisement effect monitoring event, the method determines whether the event is associated with the monitored target identifier and the user identifier of the recorded tracking data. An advertisement effect monitoring event is generally associated with its own monitored target identifier and user identifier. If these identifiers match the identifiers of the recorded tracking data, the event is considered to be associated with the identifiers (the monitored target identifier and the user identifier) of the recorded tracking data.

If the advertisement effect monitoring event is found to be associated with the monitored target identifier and the user identifier of the recorded tracking data, the method then records an effective data of advertisement effect based on the tracking data and/or information of the advertisement effect monitoring event.

Alternatively, upon occurrence of an advertisement effect monitoring event, the method identifies a recorded tracking data containing the monitored target identifier and the user identifier associated with the advertisement effect monitoring event, and records an effective data of advertisement effect based on the identified recorded tracking data and/or information of the advertisement effect monitoring event.

And exemplary way of recording an effective data of advertisement effect is marking the tracking data containing the user identifier and the monitored target identifier as an effective data of advertisement effect. Another exemplary way is recording the information associated with the advertisement effect monitoring event into a database of effective data of advertisement effect. Examples of the information associated with an advertisement effect monitoring event include the user identifier, the target identifier, the name of an advertised product, the price of the advertised product, into a database. These two ways may be combined to record more information in the effective data of advertisement effect.

Using the above process, online advertisement behaviors that may lead to a desired or benefiting effect are recorded to enable accurate monitoring of the online advertisement effect.

An advertisement effect monitoring event may be a custom-defined event. For example, the user may click on the online advertisement and eventually make a purchase of the product that's being advertised. If the advertiser (owner of the advertisement) defines such a transaction as an event that indicates a benefiting or desired effect of the advertisement, the conclusion of the transaction (purchase) may be used as an advertisement effect monitoring event.

Further, the advertisement effect monitoring event may be required to happen within a certain time period, which spans from the time a request for visiting the target webpage is sent to the server of the target website. A trackable period is defined between the time when the user clicks the online advertisement and the time the advertisement effect monitoring event occurs. The trackable period may be freely defined according to customer needs. For example, if the trackable period is defined to be 15 days, and a user concludes a purchase of the product within 15 days after clicking the online advertisement of the product, the conclusion of the purchase is considered in monitoring event occurred within the predefined time period and is thus an effective monitoring event. If the user concludes the purchase after 15 days, the transaction may be ignored and not counted as an effective monitoring event. This enables tracking of the events for monitoring the online advertisement effect using custom-defined tracking periods.

Furthermore, the method of the present embodiment may calculate advertising charges according to the effective data of advertisement effect, and generate a billing for the advertising charges. The advertiser and the advertisement website may calculate advertising fees according to the recorded effective data based on custom-defined rules and generate bills for advertising charges. The advertiser may calculate the return of investment of online advertisement based on the payments made and the benefits received from the online advertisement.

Furthermore, in the above embodiment, the steps of analyzing the request for visiting the target webpage, extracting and recording the tracking data from the request, recording the tracking data to an effective data of advertisement effect, and calculating advertising charges according to the effective data may be all carried out asynchronously. That is, these operations are not carried out in a synchronous manner at the same time or together. This minimizes the effect on the user's browsing the target webpage and the user's conducting normal online procedures on the target website.

When the advertiser launches an advertisement on a specific advertisement website, a hyperlink is provided to the advertisement. The URL of the hyperlink may be connected through a third-party link, or uses a specific web address appointed by the customer, such as the target website. At the same time, parameters for information transmission are set up in the HTML of the advertisement to define the monitored target identifier, the URL of the advertisement website, et cetera. As a user clicks the online advertisement at the advertisement website and sends a request for visiting the target webpage to the server of the target website, the parameters are attached after the URL of the hyperlink for the advertisement. An exemplary resultant URL is an extended URL which may take the following form:

http://www.xxx.com/aaa/ccc.htm?name1=variable1&name2=variable2& . . .

where one of the names may be “From” used for passing on the URL address of the originating website from which the request is sent, and another name may be “ObjectID” used for passing on the monitored target identifier.

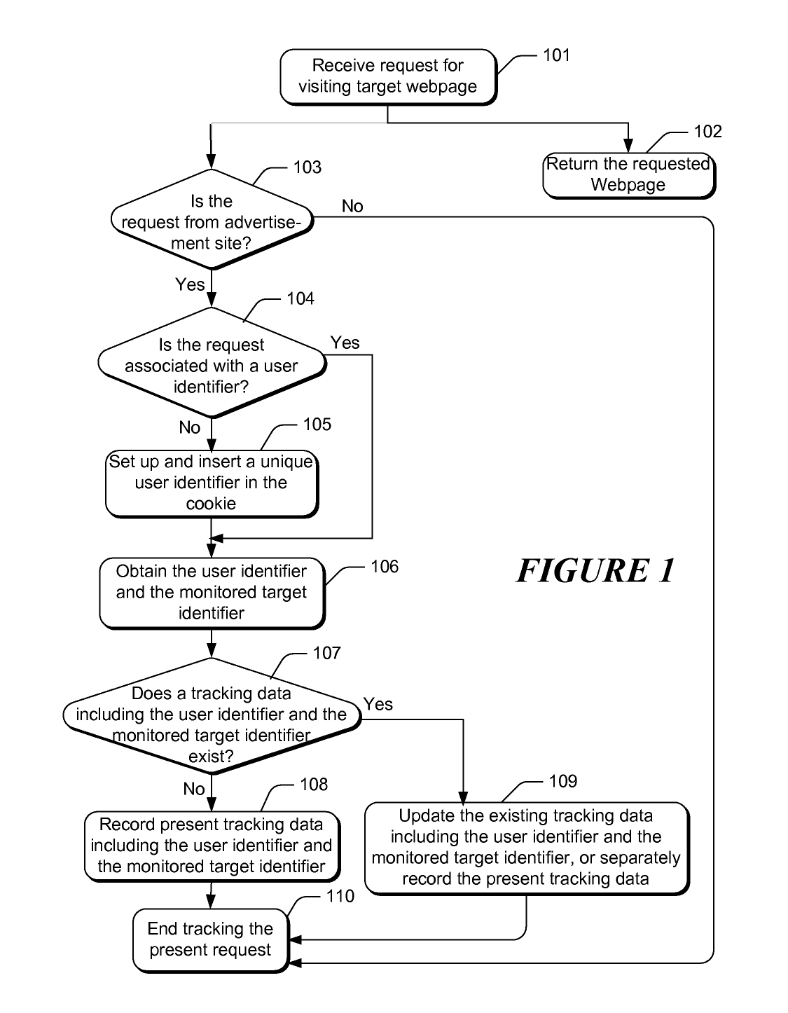

FIG. 1 is a flowchart of an exemplary method for tracking a request for visiting a target webpage. In this description, the order in which a process is described is not intended to be construed as a limitation, and any number of the described process blocks may be combined in any order to implement the method, or an alternate method.

At block 101, the server of the target website receives a user request for visiting the target webpage. For example, as the user clicks a online advertisement at the advertisement website, a request for visiting the target webpage is sent to the server of the target website. The request has an extended URL with parameters attached after the URL of the hyperlink for the advertisement.

At block 102, the server of the target website returns the requested webpage to the user who sent the request.

Block 103 obtains the URL of the present request and determines whether the request is from the advertisement website according to the parameters carried by the URL. If the answer is yes, the process enters next block 104. If not, the process proceeds to block 110.

Block 104 determines whether the request is associated with a user identifier. In one embodiment, block 104 determines whether there is a cookie sent along with the request. Absence of a cookie indicates that the user who sent the request is visiting the target website for the first time and has not been assigned a user identifier. In this case, the process proceeds to block 105 to have a cookie file established and assigned. Existence of a cookie sent along with the request indicates that the user has previously visited the target website. In this case, the method may further determine whether the cookie contains a user identifier. Absence of a user identifier indicates that the previous visit by the user to the target website was not through the advertisement site, so the process continues to block 105. If the cookie contains a user identifier, the process proceeds to block 106.

Block 105 sets up and assigns a unique user identifier to the user making the request, and inserts the unique user identifier in the cookie of the user.

Block 106 obtains the user identifier from the cookie, and also extracts the monitored target identifier (e.g., an identifier of the product being advertised) from the parameters carried by the URL of the request.

Block 107 searches for a tracking data containing the user identifier and the monitored target identifier. If such a tracking data is not found, the process continues to block 108. If such a tracking data is found, the process proceeds to block 109.

Block 108 records a present tracking data which may include tracking data such as the user identifier, the monitored target identifier and the date of the request.

Block 109 may either update the existing tracking data using a present tracking data containing the user identifier and the monitored target identifier, or separately record the present tracking data as a duplicate to the existing tracking data. The choice may be made based on actual needs. For example, where the advertising fees are calculated according to data obtained from monitoring the advertisement effect, and if the fee standard is based on sales amount, block 109 may update the existing tracking data to change the product price recorded in the tracking data to the current price and change the date of the request to the current date. But if the fee standard is based on product prices at the time the user browses the advertisement, and further requires that the higher price be used for fee calculation if the user has browsed the same product twice or more, block 109 may choose to add a new record including the tracking data such as the user identifier, the monitored target identifier and the request date, while keep the existing tracking record for potential future comparison and use.

Block 110 ends tracking the present request.

The browser of the user receives the cookie file modified or created in the above described process when it receives the webpage returned from the server of the target website. As the user ends the visit to the target website, the browser of the user stores the cookie in the hard drive of the user's computer. When the user visits the same target website next time, the stored cookie is sent to the server of the target website along with the request sent by the browser. The server of the target website may then read or modify the information contained in the cookie.

The tracking data may also record a username. The user identifier found in the cookie may take an extract form and different from the username of the user. As a user logons the target website, the system may look up a corresponding tracking data according to the user identifier contained in the cookie. If a tracking data containing the user identifier is found, the system records the username of the user into the tracking data containing the identifier of the same user.

An occurrence of an advertisement effect monitoring event may be any operation by a user with regard to an online advertisement or a product of an online advertisement. For example, the user may select a product on the target webpage and press a button to place an order, to confirm the order or to confirm the viewing of the detailed information of the product. The user may also click and browse the online advertisement. In this circumstance, a monitoring indicator may be set up to monitor the occurrence of an advertisement effect monitoring event. When advertisement effect monitoring event occurs, the user browser sends a request to the server of the target website. As the request reached the server, the monitoring indicator records a true value and starts an analysis of the effect of online advertisement.

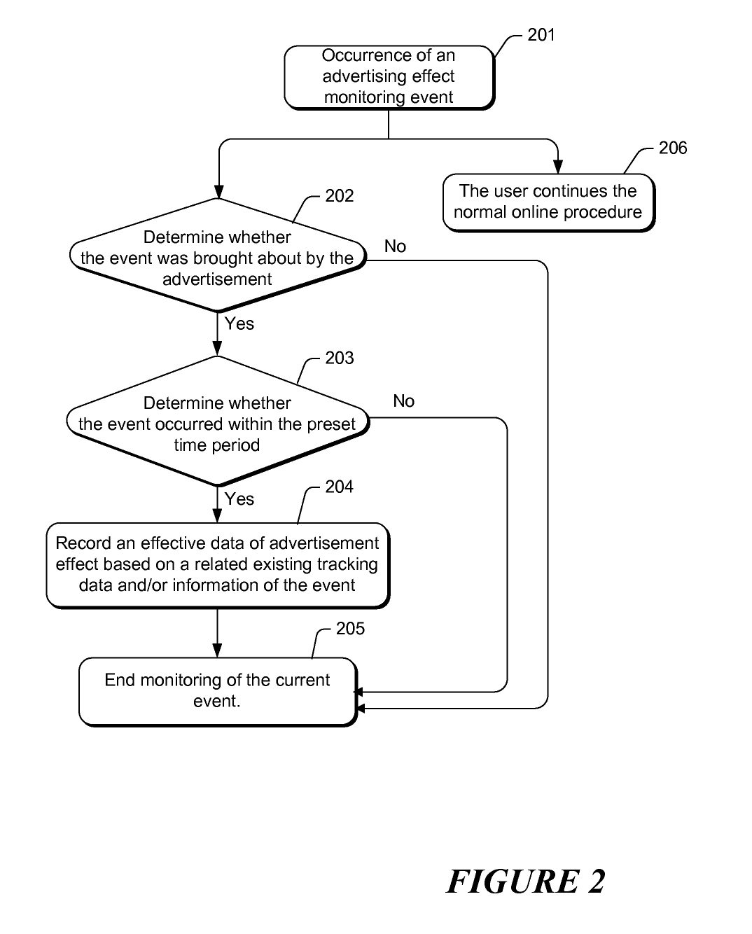

FIG. 2 is a flowchart of an exemplary method for analyzing the effect of an online advertisement. The main steps of the process are described as follows.

At block 201, the server of the target website detects an occurrence of an advertisement effect monitoring event.

Block 202 determines whether the event was brought about by the advertisement.

An advertisement effect monitoring event is usually associated with certain monitoring information such as a user identifier and a monitored target identifier. The user identifier may be obtained from a cookie of the user related to the event. The target identifier may be obtained from a database on the server of the target website, or from parameters carried by the URL of the request sent by the user to the server of the target website at the occurrence of the advertisement effect monitoring event.

The system obtains the user identifier and the target identifier associated with the advertisement effect monitoring event, and finds if there exists a tracking data containing the same user identifier and the target identifier. Existence of such a tracking data indicates that the event was caused by the advertisement, so the process continues to block 203. Absence of such a tracking data indicates that the event was not brought about by the advertisement, so the process proceeds to block 205.

Block 203 determines whether the event occurred within the predefined time period based on the request date recorded in the tracking data found at block 202. If yes, the process continues to block 204. If not, the process proceeds to block 205.

Block 204 records an effective data of advertisement effect based on the above identified existing tracking data and/or information of the advertisement effect monitoring event. For example, the identified existing tracking data may be marked as the effective data of advertisement effect.

Block 205 ends monitoring of the current event, and waits for the occurrence of a next advertisement effect monitoring event.

At block 206, the user continues the normal online procedure after having conducted the relevant event. Because the monitoring process (blocks 201-204) is performed by the monitoring system separately, the user's conducting of the normal online procedure is not affected by the monitoring process.

In the following, an exemplary implementation of the analysis of online advertisement effect is further described in detail using an example where conclusion of a transaction (e.g., purchase of a product) is used as an advertisement effect monitoring event. In this example, tracking data is stored in an advertisement tracking database (a database of advertisement tracking data), and the database is presumed to already contain some records. The predefined time period is 15 days for the purpose of illustration. Parameters are passed on to the server of the target website when the user clicks a button to confirm an order. Such parameters include monitored target identifier, user identifier, product price and purchase quantity. Upon receiving the order request, the server of the target website stores the data of the parameters which have been sent along with the order request. The recording of an effective data is conducted by marking a tracking data in the advertisement tracking database as an effective data of advertisement effect. The advertising fees are calculated based on the number of concluded transactions as a result of online advertising.

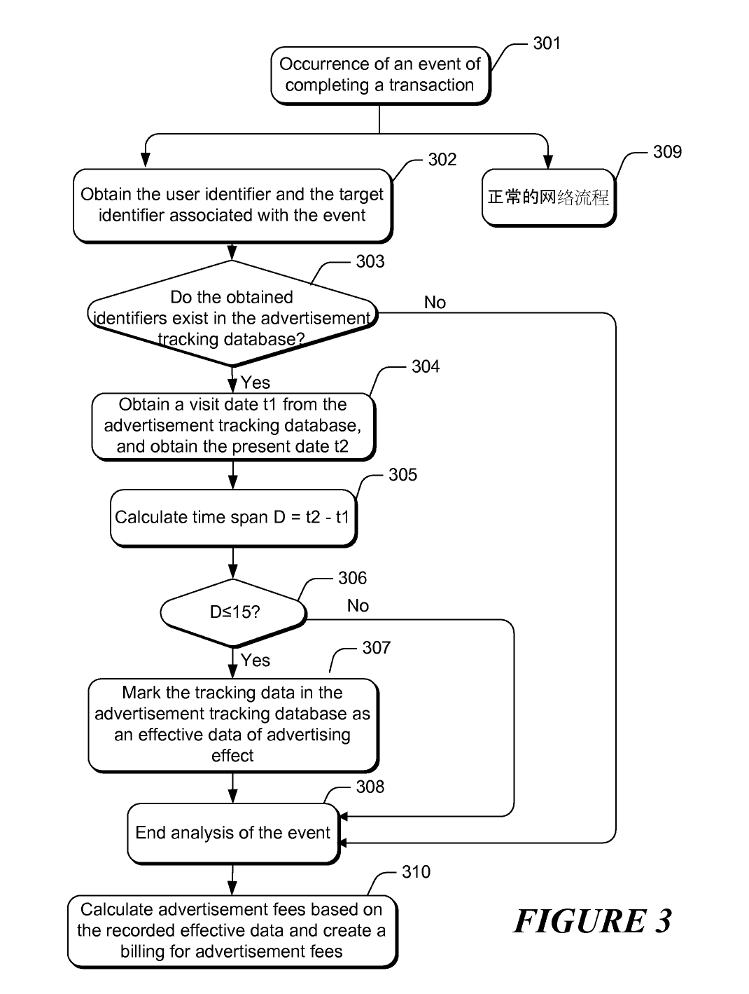

FIG. 3 is a flowchart of an exemplary process for analyzing the advertisement effect upon occurrence of an event of concluding transaction (e.g., a product purchase) and for calculating the advertising fees based on the advertisement effect. The major steps of the process in FIG. 3 are described below.

At block 301, an event of completing a transaction occurs on the target website.

Block 302 obtains the user identifier associated with the event from the user cookie associated with event, and obtains the target identifier of the event from a database of completed transactions at the server of the target website.

Block 303 determines whether the obtained identifies exist in the advertisement tracking database by searching in the advertisement tracking database for a tracking data containing the obtained user identifier and the target identifier. If such a tracking data is found, the process continues to block 304; if not, the process proceeds to block 308.

Block 304 obtains a visit date t1 in the tracking data found in the search of the advertisement tracking database at block 303. This is usually the time the user visited the advertisement with the same target identifier last time, or in the recent times. The block also obtains the present date and uses it as the present event occurrence date t2.

Block at 305 calculates time span D between the visit date t1 and present event date t2 using D=t2−t1.

Block 306 determines whether D is smaller than or equal to the predefined time period which is set to be 15 days in this example. If yes, the process continues to block 307. If not, the process proceeds to block 308.

Block 307 records an effective data of advertisement effect based on the tracking data and/or information of the advertisement effect monitoring event. For example, block 307 may mark the tracking data containing the user identifier and the target identifier as an effective data of advertisement effect.

Block 308 ends the analysis of the event of completing a transaction and waits for the occurrence of the next event.

At block 309, the user continues the normal online procedures after completing the transaction (purchase of the product).

For every occurrence of an event of completing a transaction, some data is recorded or marked as effective data of advertisement effect. The effective data associated with the same user and same target (e.g., product) thus contains accumulated information of the monitoring events associated with the same user and the same target, and can be analyzed to estimate the advertisement effect. An example of such analysis is described below with block 310.

Block 310 calculates advertising fees based on the recorded effective data of advertisement effect and create a bill of advertising fees. This may be done by looking up and calculating a quantity n which have been marked as effective data in the advertisement tracking database, and use the quantity n to calculate online advertising fees. For example, if the advertiser makes a payment of m for every successful completion of a transaction of an advertised product, the total advertising fees that need to be paid by the advertiser in the present scenario is calculated as m×n.

At the end, the advertiser may calculate the return of investment based on the advertising fees paid and the profits generated by online advertisements.

The processes using other advertisement effect monitoring events are similar to the above described process and are not repeated herein.

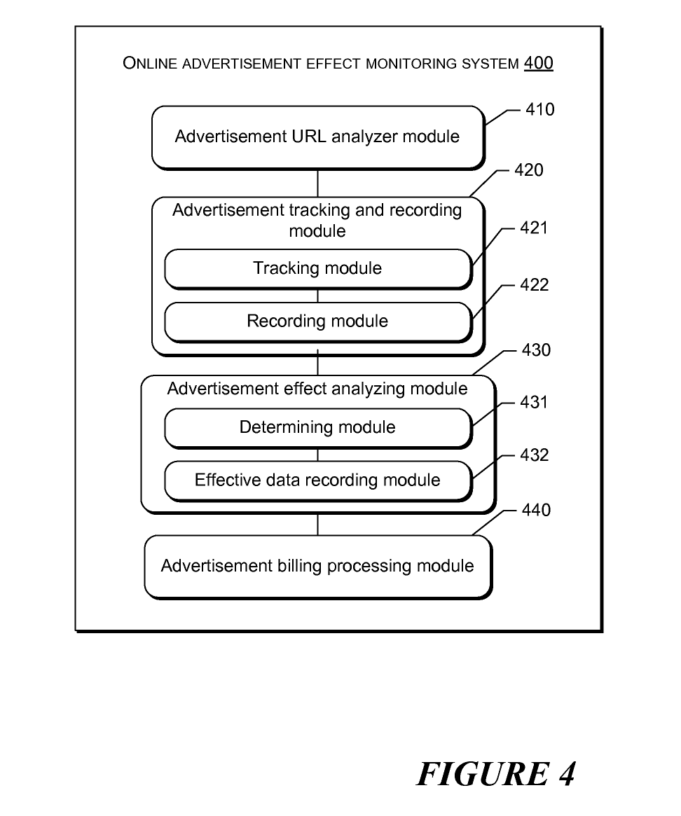

FIG. 4 is a structural diagram of an exemplary system for monitoring online advertisement effect. The monitoring system 400 has an advertisement URL analyzer module 410, an advertisement tracking and recording module 420, and an advertisement effect analyzing module 430. The advertisement URL analyzing module 410 is used for analyzing a request for visiting the target webpage and determining if the request is from an advertising website. The advertising tracking and recording module 420 is used for tracking and recording the information of the request sent from the advertising website. The advertisement effect analyzing module 430 is used for analyzing an advertisement effect monitoring event upon an occurrence of the event, and recording effective tracking data of advertisement effect.

In some embodiments, the advertisement tracking and recording module 420 is used for extracting from the request a monitored target identifier if the request is from an advertisement website, obtaining a user identifier according to the request, and recording a tracking data including the monitored target identifier and the user identifier. The advertisement tracking and recording module 420 may include a tracking module 421 and a recording module 422 to each perform some of the tracking and recording functions. The advertisement effect analyzing module 430 is used for determining, upon occurrence of an advertisement effect monitoring event, whether there is a recorded tracking data containing the monitored target identifier and the user identifier associated with the event. If affirmative, the advertisement effect analyzing module 430 records an effective data of advertisement effect based on the identified recorded tracking data and/or information of the advertisement effect monitoring event, as described herein.

The advertisement effect analyzing module 430 may include a determining module 431 and an effective data recording module 432 to each perform some of the functions.

In practice, multiple tracking data associated with different users and targets exist in an advertisement tracking database or a data file. Upon the occurrence of an advertisement effect monitoring event, the advertisement effect analyzing module may first determine whether there is a tracking data that contains the user identifier and the target identifier associated with the present event. If yes, the identified tracking data may be mocked as an effective data of advertisement effect.

The advertisement effect monitoring system 400 further includes an advertisement billing processing module 440 for calculating advertising charges according to the effective data of advertisement effect and generating a billing for the advertising charges.

A more specific exemplary embodiment of the advertisement effect monitoring system 400 works as follows.

As the server of the target website receives a request for visiting the target webpage, the advertisement URL analyzing module 410 acquires (e.g., through interception) the request and analyzes it to determine whether the request is from the advertisement website. The monitoring system 400 triggers the advertisement tracking and recording module 420 if the request is from the advertisement website, but abandons the tracking of the request if the request is not from the advertisement website. Upon triggering, the tracking module 421 extracts a monitored target identifier according to the parameters carried by the URL of the request, and determines whether there exists a user identifier related to the request. If there is none, the monitoring system 400 assigns a unique user identifier and inserts it to the user's cookie. The recording module 422 records the tracking data related to the request and stores the tracking data in an advertisement tracking database or a data file. The tracking data may include the user identifier, the target identifier and visit date. For multiple visits of the same target by the same user, the monitoring system 400 may choose to either update the existing tracking data containing the user identifier and the target identifier, or record separately the new tracking data containing the user identifier and the target identifier in addition to the existing tracking data.

Upon the occurrence of an advertisement effect monitoring event, the monitoring system 400 triggers the advertisement effect analyzing module 430. The determining module 431 of the analyzing module 430 first uses existing records in the advertisement tracking database or the data file to determine whether a tracking data exists which contains the user identifier and the target identifier associated with the present advertisement effect monitoring event. If yes, the determining module 431 further determines whether the occurrence of the event is within a predefined time period from the request date (visit date) contained in the tracking data. If yes, the tracking data is regarded as an effective data of advertisement effect, and the effective data recording module 432 accordingly records (or marks) the tracking data as an effective data of advertising effect; otherwise the tracking data is not regarded as an effective data of advertisement effect. The advertisement billing processing module 440 then calculates advertising fees based on the recorded effective data according to certain rules, and generates billing for advertising charges.

It is noted that although in the above illustrated examples that use the information is carried by a cookie, this is not meant to be a limitation. In certain circumstances, cookies may not be used due to security concerns, and as a result other methods (such as a different type of message segments) may be used to carry the user information. It should be transparent to those who are skilled in the art that handling of such user information carried by other methods is in principle the same as that illustrated above using cookies. For example, the user identifier may be extracted from the relevant message segment, or an assigned user identifier may be inserted into the message segment.

It is noted that the online advertisement effect monitoring system 400 of the present disclosure may be implemented using a computing device which is preferably a server. The computer readable media stores application programs and data (such as tracking data). Application programs may contain instructions which, when executed by processor(s), cause the processor(s) to perform actions of a process described herein (e.g., the illustrated processes of FIGS. 1-3).

It is also appreciated that a computing device may be any device that has a processor, an I/O device and a computer readable media (either an internal or an external), and is not limited to a personal computer. Especially, a computer device may be a server computer, or a cluster of such server computers, connected through network(s), which may either be Internet or an intranet.

In particular, the online advertisement effect monitoring system 400 may be implemented in a server or multiple servers that are either separate from the server(s) of the target website and the server(s) of advertisement website, or be a part of thereof.

It is appreciated that the computer readable media may be any of the suitable storage or memory devices for storing computer data. Such storage or memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

In summary, the disclosed embodiments track a request for visiting a target webpage, determine whether the request is from an advertisement website, record information related to the request which is from the advertisement website, analyze the advertisement effect upon occurrence of an advertisement effect monitoring event, and regard as an effective data only the records of those transactions in the traffic that are introduced by the advertisement and generate a benefiting effect to the advertiser. This effectively controls click fraud in online advertisement and improves the accuracy of monitoring advertisement effect. Furthermore, the advertiser may decide online advertisement payment according to the results of analyzing the advertisement effect, and can therefore more accurately estimate the return of investment of online advertisement. In addition, tracking the requests for visiting the target webpage makes it possible to trace the effect generated by the advertisement using custom-defined periods. Because both the specific event(s) for monitoring advertisement effect and the tracing period(s) can be customer defined, the system has high configurability. Finally, because in some of the disclosed embodiments, the analysis of the requests for visiting the target webpage, and the tracking, recording and analyzing of the advertisement effect monitoring events are carried out asynchronously, user's browsing the target webpage and conducting normal online procedures are not affected.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for monitoring effectiveness of an online advertisement, the method comprising:
analyzing a request for visiting a target webpage;
determining whether the request is from an advertisement website;
extracting from the request a monitored target identifier if the request is from an advertisement website;
obtaining a user identifier according to the request;
recording or updating a tracking data including the monitored target identifier and the user identifier; and
upon occurrence of an advertisement effect monitoring event associated with the monitored target identifier and the user identifier of the tracking data, recording an effective data of advertisement effect based on the tracking data and/or information of the advertisement effect monitoring event.

2. The method as recited in claim 1, wherein obtaining a user identifier according to the request comprises:
if the request contains a user identifier, extracting the user identifier from the request; and
if the request does not contain a user identifier, assigning a unique user identifier to the request and inserting the unique user identifier in the request.

3. The method as recited in claim 1, wherein recording or updating a tracking data including the monitored target identifier and the user identifier comprises:
determining if there is already a recorded tracking data including the monitored target identifier and the user identifier;
if negative, recording a present tracking data; and
if affirmative, updating the recorded tracking data using the present tracking data, or recording the present tracking data as a duplicate in addition to the recorded tracking data.

4. The method as recited in claim 1, wherein the tracking data includes a date.

5. The method as recited in claim 1, wherein registering the tracking data to an effective data of advertisement effect comprises:
determining whether the advertisement effect monitoring event occurs within a predefined period starting from a date specified in the tracking data; and
registering the tracking data to an effective data of advertisement effect if affirmative, but ignoring the event if negative.

6. The method as recited in claim 1, wherein analyzing the request for visiting the target webpage, extracting the tracking data from the request and recording the tracking data to an effective data of advertisement effect are all carried out asynchronously.

7. The method as recited in claim 1, further comprising:
calculating advertising charges according to the effective data of advertisement effect; and
generating a billing for the advertising charges.

8. The method as recited in claim 1, wherein recording an effective data of advertisement effect comprises marking the tracking data as the effective date of advertisement effect.

9. The method as recited in claim 1, wherein the advertisement effect monitoring event is a custom event.

10. The method as recited in claim 1, wherein the advertisement effect monitoring event includes any of the following: concluding a purchase of a product, ordering a product, and browsing a product.

11. A method for monitoring effectiveness of an online advertisement, the method comprising:
analyzing a request for visiting a target webpage;
determining whether the request is from an advertisement website;
extracting from the request a monitored target identifier if the request is from an advertisement website;
obtaining a user identifier according to the request;
recording or updating a tracking data including the monitored target identifier and the user identifier; and
upon occurrence of an advertisement effect monitoring event, identifying a recorded tracking data containing monitored target identifier and user identifier associated with the advertisement effect monitoring event, and recording an effective data of advertisement effect based on the identified recorded tracking data and/or information of the advertisement effect monitoring event.

12. The method as recited in claim 11, wherein obtaining a user identifier according to the request comprises:
if the request contains a user identifier, extracting the user identifier from the request; and
if the request does not contain a user identifier, assigning a unique user identifier to the request and inserting the unique user identifier in the request.

13. The method as recited in claim 11, wherein recording an effective data of advertisement effect comprises:
determining whether the advertisement effect monitoring event occurs within a predefined period starting from a date specified in the recorded tracking data; and
if affirmative, recording the effective data of advertisement effect based on the tracking data and/or the information of the advertisement effect monitoring event, but ignoring the event if negative.

14. The method as recited in claim 11, further comprising:
calculating advertising charges according to the effective data of advertisement effect; and
generating a billing for the advertising charges.

15. The method as recited in claim 11, wherein the advertisement effect monitoring event includes any of the following: concluding a purchase of a product, ordering a product, and browsing a product.

16. A system for monitoring effectiveness of online advertisement, the system comprising:
an advertisement URL analyzing module for analyzing a request for visiting the target webpage and determining if the request is from an advertising website;
an advertisement tracking and recording module for extracting from the request a monitored target identifier if the request is from an advertisement website, obtaining a user identifier according to the request, and recording a tracking data containing the monitored target identifier and the user identifier; and
an advertisement effect analyzing module for determining, upon occurrence of an advertisement effect monitoring event, whether there is a recorded tracking data containing monitored target identifier and user identifier associated with the advertisement effect monitoring event, and if affirmative, recording an effective data of advertisement effect based on the recorded tracking data and/or information of the advertisement effect monitoring event.

17. The system as recited in claim 16, further comprises:
an advertisement billing processing module for calculating advertising charges according to the effective data of advertisement effect and generating a billing for the advertising charges.

18. The system as recited in claim 16, wherein the advertisement tracking and reporting module includes:
a tracking module for extracting from the request the monitored target identifier if the request is from an advertisement website, and obtaining the user identifier according to the request; and
a recording module for recording the tracking data containing the monitored target identifier and the user identifier.

19. The system as recited in claim 16, wherein the advertisement effect analyzing module includes:
a determining module; and
an effective data recording module.

20. The system as recited in claim 19, wherein, for recording an effective data of advertisement effect, the effective data recording module performs the following:
determining whether the advertisement effect monitoring event occurs within a predefined period starting from a start date specified in the recorded tracking data; and
if affirmative, recording the effective data of advertisement effect based on the tracking data and/or information of the advertisement effect monitoring event, but ignoring the event if negative.
